(19) United States
(12) Patent Application Publication
(10) Pub. No.: US 2023/0207940 A1
(43) Pub. Date: Jun. 29, 2023

(54) Structural Battery for an Electric Vehicle

(71) Applicants: Hyundai Motor Company, Seoul (KR); Kia Corporation, Seoul (KR)

(72) Inventor: Won Ki Song, Seongnam-si (KR)

(21) Appl. No.: 17/741,773

(22) Filed: May 11, 2022

(30) Foreign Application Priority Data
Dec. 28, 2021 (KR) 10-2021-0189185

(51) Int. Cl. H01M 50/213; H01M 50/233; H01M 50/249; B60K 1/04; B62D 25/08

(52) U.S. Cl. CPC H01M 50/213; H01M 50/233; H01M 50/249; B60K 1/04; B62D 25/08; H01M 2220/20

(57) ABSTRACT

An embodiment structural battery includes a plurality of cylinder members, terminals and wiring electrically connecting the cylinder members, and a plurality of joint members mechanically connecting the cylinder members to form a framework of a vehicle body. An embodiment electric vehicle includes a vehicle body including a plurality of cylinder members mechanically connected to each other by a plurality of joint members, a battery including the cylinder members, terminals and wiring electrically connecting the cylinder members, and a body panel coupled to an exterior surface of the cylinder members.

### CROSS-REFERENCE TO RELATED APPLICATIONS

This application claims the benefit of Korean Patent Application No. 10-2021-0189185, filed on Dec. 28, 2021, which application is hereby incorporated herein by reference.

### TECHNICAL FIELD

The present disclosure relates to a structural battery for a vehicle.

### BACKGROUND

In general, a structural battery is a component part that simultaneously supports its own load and performs the charging and discharging functions of the battery.

In contrast, lithium-ion batteries account for a significant portion of the electric vehicle's weight, but do not provide a load-supporting function.

That is, in the structural battery, the battery weight contributes to the weight for load support structure, and the battery weight for solely storing energy may be substantially decreased.

Although the structural battery may show less capacity compared with the lithium-ion battery because of the limit of space used for the structural battery, the weight for the battery may be decreased, and thus, energy consumption of the vehicle for driving may also be decreased.

Furthermore, the structural battery may achieve sufficient safety with higher volumetric efficiency.

When the structural battery is applied to a vehicle, it is possible to improve the traveling distance due to the reduced weight of the vehicle.

Accordingly, it is necessary to continuously research and develop the structural battery.

The above information disclosed in this background section is only for enhancement of understanding of the background of the invention, and therefore it may contain information that does not form the prior art that is already known to a person of ordinary skill in the art.

### SUMMARY

The present disclosure relates to a structural battery of a vehicle. Particular embodiments relate to a structural battery of a vehicle that is capable of achieving mechanical strength as well as a sufficient level of voltage by applying a framework of a vehicle body as a structural battery.

Embodiments of the present invention provide a structural battery of an electric vehicle that is capable of forming the vehicle body framework by coupling of cylinder members and joint members, and thereby achieving sufficiently high voltage by coupling the cylinder members in series, while maintaining the strength of the vehicle body framework.

A structural battery of an electric vehicle includes a plurality of cylinder members, where the plurality of cylinder members are electrically connected by terminals and wiring to form a battery, and where the plurality of cylinder members are mechanically connected by joint members to form a framework of a vehicle body.

Each of the cylinder members may include a first reinforcement layer, a first insulation layer, a first collector layer, an electrode layer, a second collector layer, a second insulation layer, and a second reinforcement layer, consecutively laminated in a direction from exterior to interior.

The electrode layer may include a positive electrode layer, an electrolyte layer, and a negative electrode layer that are consecutively laminated in a direction from exterior to interior. The positive electrode layer may include a positive electrode active material formed between glass fiber pre-pregs. The negative electrode layer may include a negative electrode active material formed between glass fiber pre-pregs. The electrolyte layer may include an electrolyte formed between glass fibers.

The terminal may include a negative electrode terminal and a positive electrode terminal, one of which is inserted between the first collector layer and the electrode layer and another of which is inserted between the second collector layer and the electrode layer.

The wiring may be configured to electrically connect cylinder members disposed adjacent in a vehicle width direction, and electrically connect cylinder members disposed adjacent in a vehicle body length direction.

The wiring may be fixed by a wiring cap inserted in the cylinder member.

The wiring cap may be formed with an insertion hole configured to receive the wiring, and formed with a seating groove that exposes a preset range of the insertion hole.

The terminal may include a first end inserted into the cylinder member and a second end fitted between the wiring cap and the wiring.

The seating groove may be closed by a cover mounted to an exterior circumference of the wiring cap.

The structural battery of an electric vehicle may further include at least one clip fitted between the cylinder member and the exterior circumference of the wiring cap.

The wiring may include a positive electrode wiring and a negative electrode wiring coupled to corresponding ends of the cylinder member.

According to a structural battery of an electric vehicle according to an exemplary embodiment, the vehicle body framework is formed by the coupling of the cylinder member and the joint member, and thereby a sufficiently high voltage may be achieved by coupling the cylinder members in series, while maintaining the strength of the vehicle body framework.

As a result, according to the structural battery of an electric vehicle according to an exemplary embodiment, the battery function and the vehicle body framework may be simultaneously achieved, and thereby the vehicle may be lightweight and show improved mileage.

Other effects that may be obtained or are predicted by an exemplary embodiment will be explicitly or implicitly described in a detailed description of the present invention. That is, various effects that are predicted according to an exemplary embodiment will be described in the following detailed description.

### BRIEF DESCRIPTION OF THE DRAWINGS

FIG. 1 is a schematic diagram of an electric vehicle applied with a structural battery of an electric vehicle according to an exemplary embodiment.

FIG. 2 is a schematic diagram of a structural battery of an electric vehicle according to an exemplary embodiment.

FIG. 3 is an equivalent circuit diagram of FIG. 2.

FIG. 4 illustrates a cylinder member applied to a structural battery of an electric vehicle according to an exemplary embodiment.

FIG. 5 is an enlarged view of a joint portion of a structural battery of an electric vehicle according to an exemplary embodiment.

FIG. 6 illustrates a wiring cap applied to a structural battery of an electric vehicle according to an exemplary embodiment.

FIG. 7 is a cross-sectional view of FIG. 6 along line A-A, and illustrates a joint structure of a wiring cap applied to a structural battery of an electric vehicle according to an exemplary embodiment.

The following reference labels may be used in connection with the accompanying drawings to describe particular embodiments of the present invention.

| | |
|---|---|
| 1: structural battery | 3: panel |
| 10: cylinder member | 11: first reinforcement layer |
| 12: first insulation layer | 13: first collector layer |
| 14: electrode layer | 140: positive electrode layer |
| 141: the glass fiber pre-preg | |
| 142: positive electrode active | |
| material | |
| 143: electrolyte layer | |
| 144: electrolyte | 145: glass fiber |
| 146: negative electrode layer | |
| 147: negative electrode active | |
| material | |
| 15: second collector layer | 16: second insulation layer |
| 17: second reinforcement layer | 20: terminal |
| 21: positive electrode terminal | 23: negative electrode terminal |
| 30: wiring | 31: positive electrode wiring |
| 33: negative electrode wiring | 40: wiring cap |
| 41: insertion hole | 43: seating groove |
| 45: cover | 47: clip |
| 50: joint member | 51: connector |
| 53: bolt | 55: nut |

### DETAILED DESCRIPTION OF ILLUSTRATIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify the present invention, parts that are not related to the description will be omitted, and the same elements or equivalents are referred to with the same reference numerals throughout the specification.

Also, the size and thickness of each element are arbitrarily shown in the drawings, but the present invention is not necessarily limited thereto, and in the drawings, the thickness of layers, films, panels, regions, etc., are exaggerated for clarity.

In addition, in the following description, dividing names of components into first, second, and the like is to divide the names because the names of the components are the same as each other and an order thereof is not particularly limited.

In addition, unless explicitly described to the contrary, the word “comprise” and variations such as “comprises” or “comprising”, will be understood to imply the inclusion of stated elements but not the exclusion of any other elements.

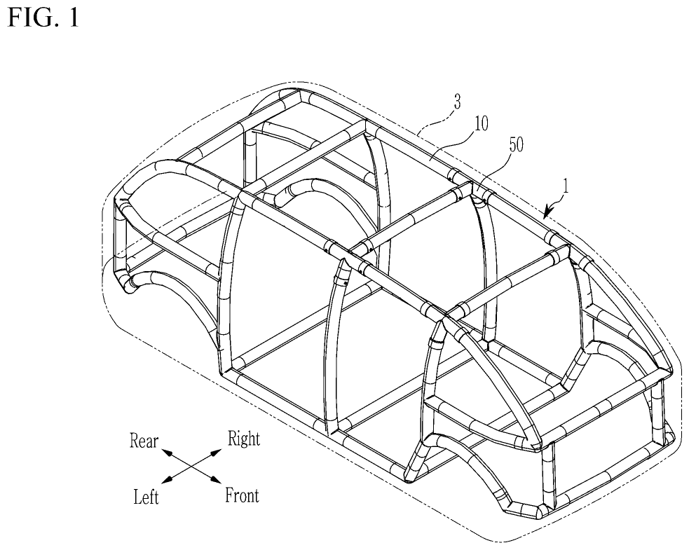

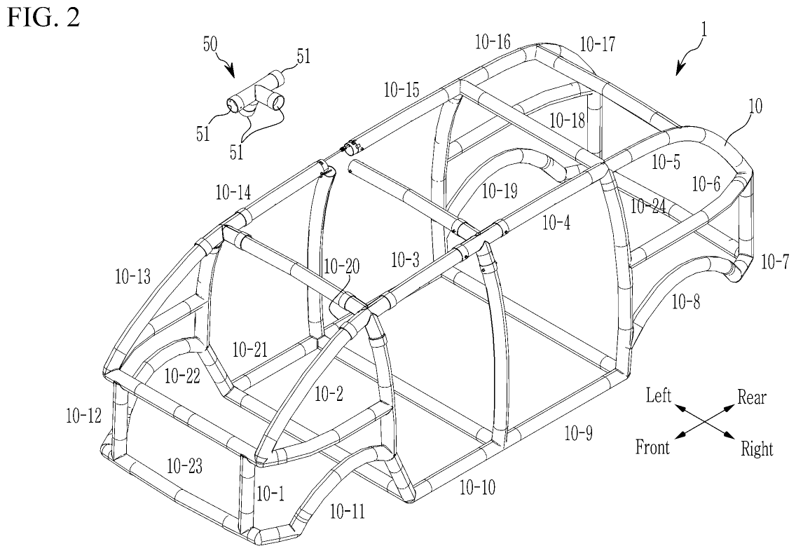

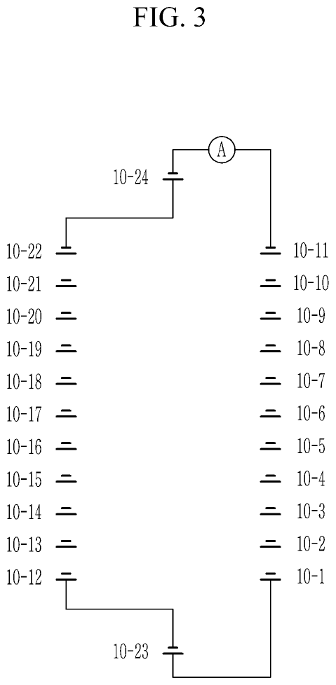

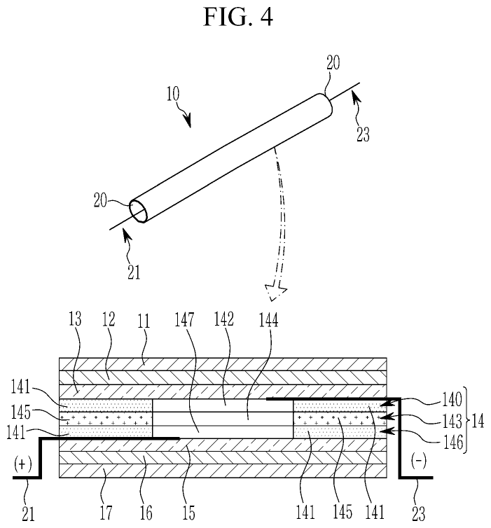

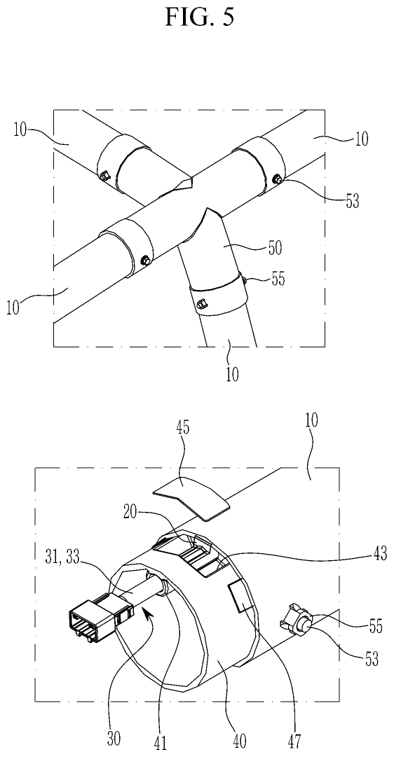

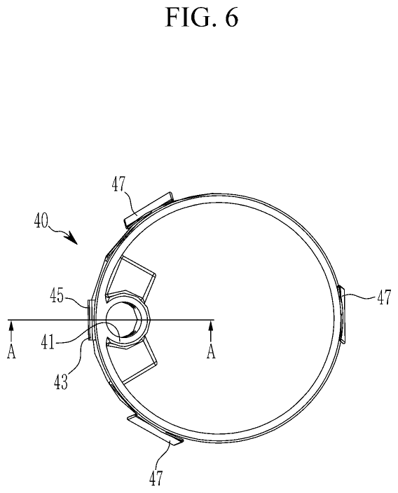

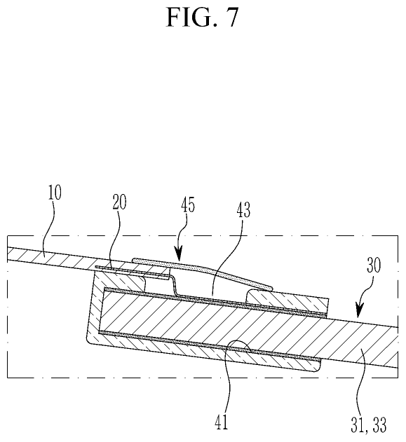

FIG. 1 is a schematic diagram of an electric vehicle applied with a structural battery of an electric vehicle according to an exemplary embodiment. FIG. 2 is a schematic diagram of a structural battery of an electric vehicle according to an exemplary embodiment. FIG. 3 is an equivalent circuit diagram of FIG. 2. FIG. 4 illustrates a cylinder member applied to a structural battery of an electric vehicle according to an exemplary embodiment. FIG. 5 is an enlarged view of a joint portion of a structural battery of an electric vehicle according to an exemplary embodiment. FIG. 6 illustrates a wiring cap applied to a structural battery of an electric vehicle according to an exemplary embodiment. FIG. 7 is a cross-sectional view of FIG. 6 along line A-A, and illustrates a joint structure of a wiring cap applied to a structural battery of an electric vehicle according to an exemplary embodiment.

In this specification, the term “vehicle length direction” may refer to a length direction (i.e., front-and-rear direction) of the vehicle body, the term “vehicle width direction” may refer to a transverse direction of the vehicle body, and the term “vertical direction” may refer to a height direction of the vehicle body.

Referring to FIG. 1, a structural battery 1 of an electric vehicle according to an exemplary embodiment includes a plurality of cylinder members 10. The plurality of cylinder members 10 may be connected to one another to form a vehicle body framework while functioning as a battery.

Thus, the structural battery 1 of an electric vehicle according to an exemplary embodiment may simultaneously perform a function of supporting load and a function of charging and discharging.

A body panel 3 is coupled to an exterior surface of the plurality of cylinder members 10.

Referring to FIG. 2 and FIG. 3, in the structural battery 1 of an electric vehicle according to an exemplary embodiment, the plurality of cylinder members 10 are electrically connected by a terminal 20 and a wiring 30 to form a battery (refer also to FIG. 4 and FIG. 5)

In addition, in the structural battery 1 of an electric vehicle, the plurality of cylinder members are mechanically connected by a joint member 50 to form a framework of a vehicle body.

In the structural battery 1 of an electric vehicle, the cylinder members 10 forming an outer framework of the vehicle body may be connected in series in the order of a positive electrode, a negative electrode, and so on.

For example, the cylinder members 10 may be connected in series along the vehicle body outer framework, in the sequence of 10-1, 10-2, . . . , and 10-11, and in the sequence of 10-23, 10-12, 10-13, . . . , 10-22, and 10-24.

Thus, in the structural battery 1 of an electric vehicle, the series connection of the cylinder member 10 may form an increased voltage to drive the electric vehicle.

Referring to FIG. 4, each of the cylinder members 10 may include a first reinforcement layer 11, a first insulation layer 12, a first collector layer 13, an electrode layer 14, a second collector layer 15, a second insulation layer 16, and a second reinforcement layer 17, consecutively laminated in a direction from exterior to interior.

For example, each of the first reinforcement layer 11 and the second reinforcement layer 17 may include a carbon fiber pre-preg.

Each of the first insulation layer 12 and the second insulation layer 16 may include a glass fiber pre-preg.

The first collector layer 13 and the second collector layer 15 may be made of a carbon fiber material.

In addition, the electrode layer 14 includes a positive electrode layer 140, an electrolyte layer 143, and a negative electrode layer 146 that are consecutively laminated in a direction from exterior to interior.

The positive electrode layer 140 may include a positive electrode active material 142 formed between the glass fiber pre-pregs 141.

The negative electrode layer 146 may include a negative electrode active material 147 formed between the glass fiber pre-pregs 141.

The electrolyte layer 143 may include an electrolyte 144 formed between glass fibers 145.

At this time, in the cylinder member 10, the glass fiber pre-preg is employed as an insulation layer for insulation from the carbon fiber pre-preg forming the first reinforcement layer 11 or the second reinforcement layer 17.

The cylinder member 10 may be formed in a required length appropriate for locations in the vehicle body framework.

In addition, the terminal 20 is coupled to the cylinder member 10 for electrical connection.

The terminal 20 may include a positive electrode terminal 21 and a negative electrode terminal 23.

At this time, the positive electrode terminal 21 and the negative electrode terminal 23 may be inserted to corresponding sides of the cylinder member 10.

One of the positive electrode terminal 21 and the negative electrode terminal 23 may be inserted between the first collector layer 13 and the electrode layer 14, and another one thereof may be inserted between the second collector layer 15 and the electrode layer 14.

For example, the positive electrode terminal 21 may be inserted between the second collector layer 15 and the electrode layer 14, and the negative electrode terminal 23 may be inserted between the first collector layer 13 and the electrode layer 14.

In more detail, the positive electrode terminal 21 may be disposed to contact the second collector layer 15 and the negative electrode layer 146 of the electrode layer 14, and the negative electrode terminal 23 may be disposed to contact the first collector layer 13 and the positive electrode layer 14o of the electrode layer 14.

At this time, the glass fiber pre-preg 141 is employed to the electrode layer 14 for insulation from the terminal 20.

Referring to FIG. 5 to FIG. 7, the wiring 30 is configured between the cylinder members 10 for electrical connection.

The wiring 30 may electrically connect the cylinder members 10 disposed adjacent in the vehicle width direction.

In addition, the wiring 30 may electrically connect the cylinder members 10 disposed adjacent in the vehicle body length direction.

A length of the wiring 30 may be varied to correspond to the length of respective cylinder members 10.

The wiring 30 includes a positive electrode wiring 31 and a negative electrode wiring 33 coupled to corresponding ends of the cylinder member 10.

For example, the positive electrode wiring 31 may have a first end connected to the cylinder member 10, and have a second end to be coupled to a positive electrode bracket for connection to the negative electrode wiring 33 of an adjacent cylinder member 10.

In addition, the negative electrode wiring 33 may have a first end connected to the cylinder member 10, and have a second end coupled to a negative electrode bracket for connection to the positive electrode bracket of the positive electrode wiring 31.

The wiring 30 may be fixed by a wiring cap 40 inserted in the cylinder member 10.

The wiring cap 40 may be formed with an insertion hole 41 configured to receive the wiring 30.

The insertion hole 41 may be formed in a diameter that may easily receive the wiring 30.

In addition, the wiring cap 40 may be formed with a seating groove 43 that exposes a preset range of the insertion hole 41.

The seating groove 43 may be formed in a generally quadrangular shape.

The seating groove 43 may be closed by a cover 45 mounted to an exterior circumference of the wiring cap 40.

The cover 45 may be adhered to the wiring cap 40.

At this time, the terminal 20 includes a first end inserted into the cylinder member 10, passes through the seating groove 43, and includes a second end fitted between the wiring cap 40 and the wiring 30.

In addition, at least one clip 47 may be fitted between the cylinder member 10 and the exterior circumference of the wiring cap 40.

The clip 47 may be fixed to the wiring cap 40 and have an open leg (which is apart from the wiring cap 40) toward the cylinder member 10.

Thus, when the clip 47 is inserted into the cylinder member 10, the clip 47 may stably support the wiring cap 40 against the cylinder member 10.

In addition, the joint member 50 is bolt-engaged with an exterior surface of the cylinder member 10, by a bolt 53.

At this time, the bolt 53 penetrates the cylinder member 10 and the joint member 50 to structurally combine the cylinder member 10 and the joint member 50.

Ends of the bolt 53 exposed from the joint member 50 are coupled with nuts 55.

The joint member 50 is formed with a number of connectors 51 corresponding to a required number of the cylinder members 10 to be connected.

The joint member 50 may be made of an aluminum material.

The number of connectors 51 may be 3, 4, or any other number depending on the design features.

Therefore, according to the structural battery 1 of an electric vehicle according to an exemplary embodiment, a cost increase factor for strengthening the vehicle body framework structure by composite materials may be offset by the structural battery that contributes to the mechanical strength of the vehicle body.

In addition, according to the structural battery 1 of an electric vehicle according to an exemplary embodiment, the vehicle body framework is formed by the coupling of the cylinder member 10 and the joint member 50, and thereby sufficiently high voltage may be achieved by coupling the cylinder members 10 in series, while maintaining the strength of the vehicle body framework.

Furthermore, the structural battery 1 of an electric vehicle may form a sufficiently high voltage required for component parts consuming a high power.

As a result, according to the structural battery 1 of an electric vehicle according to an exemplary embodiment, the battery function and the vehicle body framework may be simultaneously achieved, and thereby the vehicle may be lightweight and show improved mileage.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A structural battery comprising:
a plurality of cylinder members;
terminals and wiring electrically connecting the cylinder members; and
a plurality of joint members mechanically connecting the cylinder members to form a framework of a vehicle body.

2. The structural battery of claim 1, wherein each of the cylinder members comprises a first reinforcement layer, a first insulation layer, a first collector layer, an electrode layer, a second collector layer, a second insulation layer, and a second reinforcement layer, consecutively laminated in a direction from an exterior to an interior.

3. The structural battery of claim 2, wherein:
the electrode layer comprises a positive electrode layer, an electrolyte layer, and a negative electrode layer consecutively laminated in the direction from the exterior to the interior;
the positive electrode layer comprises a positive electrode active material between first glass fiber pre-pregs;
the negative electrode layer comprises a negative electrode active material between second glass fiber pre-pregs; and
the electrolyte layer comprises an electrolyte between glass fibers.

4. The structural battery of claim 2, wherein each terminal comprises a negative electrode terminal and a positive electrode terminal, a first of which is inserted between the first collector layer and the electrode layer, and a second of which is inserted between the second collector layer and the electrode layer.

5. The structural battery of claim 2, wherein the wiring electrically connects the cylinder members disposed adjacent in a vehicle width direction and electrically connects the cylinder members disposed adjacent in a vehicle body length direction.

6. The structural battery of claim 1, wherein the wiring comprises a positive electrode wiring and a negative electrode wiring coupled to corresponding ends of a respective cylinder member.

7. A structural battery comprising:
a plurality of cylinder members;
terminals and wiring connecting the cylinder members;
a wiring cap inserted in each cylinder member to fix the wiring; and
a plurality of joint members mechanically connecting the cylinder members to form a framework of a vehicle body.

8. The structural battery of claim 7, wherein the wiring cap comprises an insertion hole configured to receive the wiring and a seating groove that exposes a preset range of the insertion hole.

9. The structural battery of claim 8, further comprising a cover mounted to an exterior circumference of the wiring cap to close the seating groove.

10. The structural battery of claim 7, wherein each terminal comprises:
a first end inserted into a respective cylinder member; and
a second end fitted between the wiring cap and the wiring.

11. The structural battery of claim 7, further comprising a clip fitted between a respective cylinder member and an exterior circumference of the wiring cap.

12. An electric vehicle comprising:
a vehicle body comprising a plurality of cylinder members mechanically connected to each other by a plurality of joint members;
a battery comprising the cylinder members;
terminals and wiring electrically connecting the cylinder members; and
a body panel coupled to an exterior surface of the cylinder members.

13. The vehicle of claim 12, wherein each of the cylinder members comprises a first reinforcement layer, a first insulation layer, a first collector layer, an electrode layer, a second collector layer, a second insulation layer, and a second reinforcement layer, consecutively laminated in a direction from an exterior to an interior.

14. The vehicle of claim 13, wherein:
the electrode layer comprises a positive electrode layer, an electrolyte layer, and a negative electrode layer consecutively laminated in the direction from the exterior to the interior;
the positive electrode layer comprises a positive electrode active material between first glass fiber pre-pregs;
the negative electrode layer comprises a negative electrode active material between second glass fiber pre-pregs; and
the electrolyte layer comprises an electrolyte between glass fibers.

15. The vehicle of claim 13, wherein each terminal comprises a negative electrode terminal and a positive electrode terminal, a first of which is inserted between the first collector layer and the electrode layer, and a second of which is inserted between the second collector layer and the electrode layer.

16. The vehicle of claim 13, wherein the wiring electrically connects the cylinder members disposed adjacent in a vehicle width direction and electrically connects the cylinder members disposed adjacent in a vehicle body length direction.

17. The vehicle of claim 12, wherein the wiring comprises a positive electrode wiring and a negative electrode wiring coupled to corresponding ends of a respective cylinder member.

18. The vehicle of claim 12, further comprising a wiring cap inserted in each cylinder member, wherein the wiring cap is configured to fix the wiring.

19. The vehicle of claim 18, wherein the wiring cap comprises an insertion hole configured to receive the wiring and a seating groove that exposes a preset range of the insertion hole.

20. The vehicle of claim 19, further comprising a cover mounted to an exterior circumference of the wiring cap to close the seating groove.
